(19) United States
(12) Patent Application Publication
(10) Pub. No.: US 2008/0228497 A1
(43) Pub. Date: Sep. 18, 2008

(54) Method For Communication and Communication Device

(75) Inventors: Thomas Portele, Bonn (DE); Holger R. Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,007

(22) PCT Filed: Jul. 3, 2006
(86) PCT No.: PCT/IB06/52233

§ 371 Date: Jan. 8, 2008

(30) Foreign Application Priority Data
Jul. 11, 2005 (EP) 05106320.4

(51) Int. Cl. G10L 21/06

(52) U.S. Cl. 704/276; 704/E21.019

(57) ABSTRACT

The invention describes a method for communication by means of a communication device (DS), in which synthesized speech (ss) is output from the communication device (DS), and in which light signals (ls) are output simultaneously with the synthesized speech (ss) in accordance with the semantic content of the synthesized speech (ss). Furthermore, an appropriate communication device (DS) is described.

The invention relates to a method for communication and a communication device, particularly a dialog system.

Recent developments in the area of man-machine interfaces have led to widespread use of technical devices which are operated through a dialog between a device and the user of the device. Some dialog systems are based on the display of visual information and manual interaction on the part of the user. For instance, almost every mobile telephone is operated by means of an operating dialog based on showing options in a display of the mobile telephone, and the user's pressing the appropriate button to choose a particular option. Moreover, speech-based dialog systems, or at least partially speech-based dialog systems, exist, which allow a user to enter into a spoken dialog with the dialog system. The user can issue spoken commands and receive visual and/or audible feedback from the dialog system. One such example might be a home electronics management system, where the user issues spoken commands to activate a device e.g. the video recorder. A common feature of these dialog systems is an audio interface for recording and processing sound input including speech and for generating and rendering synthetic speech to the user. Besides the above-mentioned dialog systems, further communication devices are available which feature a speech output for reporting information to the user, without the user actually being able to enter into a dialog with the device. Therefore, in the following, devices and systems which are able to generate and output synthesized speech are termed “communication device”, whereby a dialog system is a particularly preferred variation of such a communication device, since it offers a very natural bilateral interaction between user and system.

Attempts have been made to support the understanding of synthesized speech by simultaneously displaying a corresponding facial animation, for example by showing the appropriate lip movements. Since more than twenty years, research has been carried out to integrate such facial animation of an artificial character with synthetic speech, thus creating an artificial “talking head”. Several products are on the market supporting talking animated agents.

An important issue is the synchronization of the speech and the pertinent lip movements. For more open sounds like /a/, the mouth has to be open wide, for other sounds like /i/ the mouth is fairly closed, for a /u/ the mouth is closed and rounded, etc. If the synchronization is successful, the synthetic speech is easier to understand, whereas, if the synchronization is off, understanding is made even more difficult: for example, if a /b/ is synthesized acoustically, while simultaneously showing lip movements belonging to a /g/ on a display, the visual stimulus generally dominates, so that the user is more likely to misinterpret the synthesized speech.

Another issue is the synchronization between speech and pertinent facial and body gestures. Although there are differences between cultures, important words are usually emphasized by a higher intonation and/or gestures like raising one or both eyebrows, shrugging the shoulder, etc. Questions can be emphasized by a rise in intonation at the end of the sentence, and by directly looking at the dialog partner, often accompanied by a further widening of the eyes. Here too, correct synchronization can assist in understanding, whereas synchronization that is “off” can actually impair the understanding of synthesized speech.

So far, research and commercial development alike have concentrated on the realization of a more natural behaviour of facial appearance and of lips movements in particular.

Complex and expensive simulations in usability labs showed that if the synchronization between speech and visual cues is imperfect (i.e. not corresponding to the experience from human-to-human communication) the intelligibility of the speech is decreased. If acoustic-prosodic cues are not adequately mirrored by the animated character, i.e. are not similar to human behaviour, the comprehension on the part of the user of the agent as a whole is made more difficult.

Although much research has been carried out, the difficulties in creating a credible multimodal agent remain. One main reason is that humans are extremely sensitive to facial expressions and other non-verbal cues, due to the important role that communication has had in the history of mankind.

It is therefore an object of the invention to provide a method for communication and a communication device, which provide a consistent and supportive visual enhancement of speech output.

In the method for communication according to the invention, synthesized speech is output acoustically from a communication device. Simultaneously to the synthesized speech output, light signals are emitted, that depend on the semantic content of the output synthesized speech.

Experiments underlying the invention have shown that, with such a visualisation of an abstract speech representation, the understanding of the output synthesized speech is increased. This is in particular the case when the user, i.e. the listener or viewer, has learned how to interpret the simultaneously synthesized speech and light signals. Learning follows automatically by observing the output information. The advantage of the invention is attained particularly when no similarity exists between the output light signals and the lip movements/facial gestures corresponding to the output synthesized speech.

The invention is based in particular on the knowledge that, in visually supporting the understanding of speech, it is important to refrain from outputting visual information that contradicts the acoustically output speech, e.g. presenting a /b/ acoustically to a user, whilst visually displaying lip movements belonging to a /g/ on a display. Avoiding such “traps” in visually supporting speech understanding has not been ensured by the methods known to date. Only now, with the method according to the invention, has it been made possible to avoid such traps. This is also because no connections between speech and output light signals have been memorized by the user before using the method a first time, so that misinterpretations are not possible.

The dependent claims and the subsequent description disclose particularly advantageous embodiments and features of the invention.

According to the invention, light signals are output depending on the semantic content of the output synthesized speech. Preferably however, the output light signals also depend on the prosodic content, in particular the prosodic content relevant with respect to the semantic content. The term “prosodic content” means characteristics of speech, apart from the actual speech sounds, such as pitch, rhythm, and volume. The emotional content of the speech is also brought across by such prosodic elements. Furthermore, the prosodic elements also define semantic information such as sentence structure, intonation, etc.

In particular, the currently output light signals depend on the currently output synthesized speech. A suitable context for the determination of appropriate light patterns can be a whole utterance, a sentence, and syntactically determined sentence elements like phrases. Alternatively or additionally, it is possible that the output light signals only relate to the word or the speech sound being currently output.

Preferably, the colour, intensity and duration and/or the shape (outline or contour) of the output light signals depend on the output synthesized speech.

In a particularly preferred embodiment of the invention, the output light signals correspond to or are based on predefined, preferably abstract, light patterns. The term “abstract” implies that no attempt is made to represent lip movements or facial gestures of the output synthesized speech by means of the light patterns. A light pattern can comprise a set of parameters for describing a light signal to be output. Application of such simple light patterns can considerably increase the success of the invention.

A light pattern preferably comprises only a comparatively low optical resolution. A light pattern comprises preferably less than 50 light fields, more preferably less than 30, even more preferably less than 20, particularly preferably less than 10 light fields. Embodiments implementing between 5 and 10 light fields have proven, in experiments underlying the invention, to be easily learned by the user, whilst still offering an effective support of the speech understanding.

Preferably, the light fields have the same dimensions and form. A light pattern can, in particular, be defined through colour, intensity, and duration of the light signals emitted by the individual light fields. In addition, a light pattern can be further defined by information pertaining to the behaviour over time of the colour, intensity and duration of the light signals emitted by the individual light fields, as well as to the spatial arrangement of the light signals emitted by the light fields at a particular time. A light pattern can also be defined by a set of light patterns that appear consecutively or simultaneously. A light field preferably comprises one or more coloured LEDs (Light Emitting Diodes).

According to the invention, the emitted light signals depend on the semantic content of the output synthesized speech. To this end, semantic tags can be constructed during the speech generation process, in particular by an output planning module or by a language planning module, from the output text and/or an abstract representation, preferably a semantic representation, of the output text, i.e. the text which is to be output.

The output text and/or abstract representation can be forwarded to the output planning module or the language planning module, by a dialog management module.

A light pattern or set of light patterns can thereby be assigned to each semantic tag, so that the speech output is supported or enhanced by the output of light patterns that correspond to the semantic tags previously constructed according to the output text and/or an abstract representation of the output text.

Therefore, each tag, in particular each semantic tag, triggers the output of a certain light pattern. In the case that several tags occur simultaneously in a segment of speech, several corresponding light patterns are preferably output in combination or in parallel by combining or overlaying the appropriate light signals. For example, sentence level tags can determine in which general colour the light patterns for word level patterns are displayed. Questions can have a basic colour (e.g. red) different to that of statements (e.g. green). Similarly, dialog state tags can also influence the light pattern (e.g., responses to an input that was recognized with only a low confidence level can be given a reduced overall light intensity). Word and phoneme tags or light patterns can be overlaid over these more general tags or light patterns respectively. Thus, it is achieved that the implemented visualization does not—or does not only—abstract the natural mouth pattern, but goes further in that it implements abstract patterns to enhance the user's understanding of the synthesized speech output.

The semantic tags meanwhile describe the semantic content, preferably based on predefined semantic criteria. For example, the following semantic tags, individually or combined, may be defined:

Dialog state tags, such as:
Confirmation required (does the output synthesized speech require a confirmation?);
Confidence level critical (is the confidence level critical?);
System information output (does the output synthesized speech comprise system information?);

Sentence level tags, such as:
does the output speech comprise a self-confident statement?
does the output speech comprise a polite statement?
does the output speech comprise an unsure statement?
does the output speech comprise a polite statement in question form?
does the output speech comprise an open question?
does the output speech comprise a rhetorical question?
does the output speech comprise a polite order?
does the output speech comprise a strict order?
does the output speech comprise a functionally important sentence, i.e. is this sentence meaning essential for proceeding successfully with the dialog?
does the output speech comprise a polite sentence?
does the output speech comprise a sensitive sentence, i.e. does this sentence contain personally sensitive information?

Word/phrase level tags, such as:
does the output speech comprise a communicative keyword? (i.e. if this word's meaning is understood wrongly, then the whole sentence meaning is wrong)
does the output speech comprise a central verb phrase?
does the output speech comprise an object-phrase correlated to the central phrase?
does the output speech comprise a verb phrase of action?

A semantic tag to a certain criterion can then be defined by an answer of “yes” or “no”, or by a quantitative statement, such as a number between 0 and 100, whereby the number is greater in proportion to the certainty with which the corresponding question can be answered with “yes”. A light pattern can be assigned to each possible answer to each question.

Further examples for an association of light patterns to words and phonemes can be
POS (Parts of Speech)-related tags (verb, noun, pronoun, etc.): for example, different shapes of light patterns can be assigned to the various types of words;
vowel-related tags: for example, light patterns with greater light intensity can be assigned to all vowels, or light patterns with different intensity can be assigned to the different vowels;
fricative-related tags: different light patterns can be assigned to the different fricatives.

According to a preferred realisation, the emitted light signals depend on the prosodic content of the output synthesized speech. This applies in particular to the prosodic content that has a semantic significance. For example, a sentence is parsed by punctuation marks such as comma, exclamation mark, question mark etc., generally brought across by intonation of certain sentence segments, or by raising or lowering the voice at the end of the sentence. Naturally, other prosodic markers or tags—such as the mood of the speaker—can be taken into consideration in addition to the prosodic markers or tags having a semantic significance when emitting the light signals.

Along with a method for communication, the invention also comprises a communication device. The communication device according to the invention comprises a speech output unit for outputting synthesized speech, and a light signal output unit for outputting light signals. A processor unit is realised so that light signals are output in accordance with the semantic content of the output synthesized speech. Furthermore, the communication device can comprise a speech synthesis unit, such as a Text-To-Speech (TTS) converter, for example as part of the speech output unit or in addition to the speech output unit. The communication device can be a dialog system or part of a dialog system.

For construction of semantic tags from the output text and/or an abstract representation, the communication device preferably comprises a language planning unit or an output planning unit.

According to a preferred embodiment of the invention, the communication device comprises a storage unit for storing semantic tags, and for storing the light patterns assigned to the semantic tags.

Further developments of the device claim corresponding to the dependent method claims also lie within the scope of the invention. The communication device can comprise any number of modules, components, or units, and can be distributed in any manner.

Other objects and features of the present invention will become apparent from the following detailed descriptions considered in conjunction with the accompanying drawings. It is to be understood, however, that the drawings are designed solely for the purposes of illustration and not as a definition of the limits of the invention.

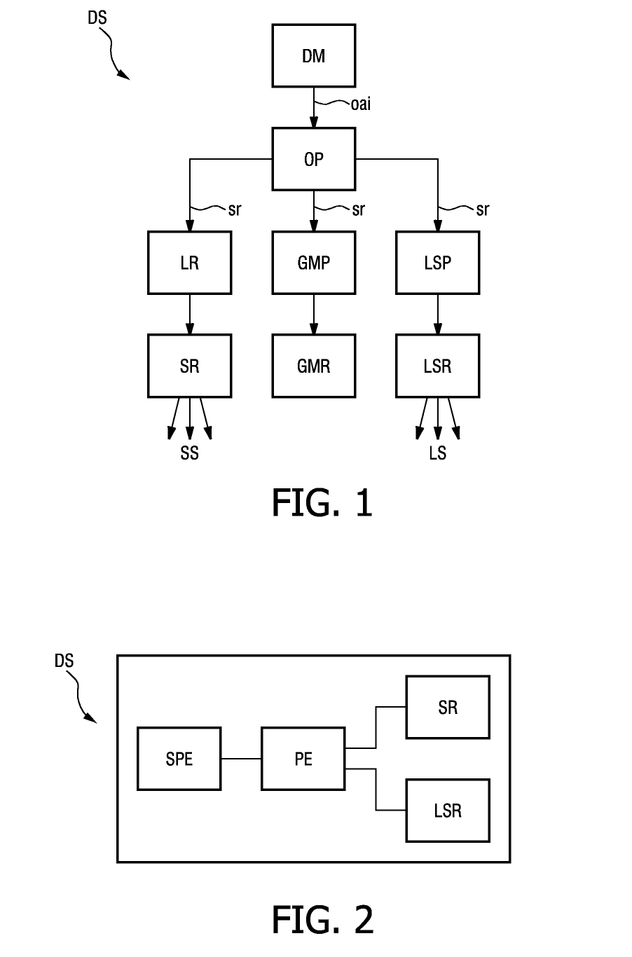

FIG. 1 an information flow diagram within a dialog system;

FIG. 2 a block diagram of a communication device.

FIG. 1 shows the information flow of the method of communication with a communication device according to the invention, particularly the information flow for an example of synthesized speech, output by a dialog system, being supported by the output of light signals. Here, the dialog system is exemplary for a communication device.

First, a dialog management module DM of the dialog system DS decides upon the output action to be taken. Defining output action information oai corresponding to this output action is forwarded in a next step to an output planning module OP of the dialog system DS.

The output planning module OP selects the appropriate output modalities and transmits the corresponding semantic representation sr to the modality output rendering modules of the dialog system DS. The diagram shows, as an example of modality output rendering modules, a language rendering module LR, a graphics and motion planning module GMP, and a light signal planning module LSP.

For example, the output planning module OP sends a semantic representation sr of a sentence to be spoken by the system to the language rendering module LR. There, the semantics are processed into (possibly meta-tag enriched) text that is subsequently forwarded to a speech rendering module SR, which is provided with a loudspeaker for outputting the rendered speech.

Accordingly, the semantic representation sr of a sentence is converted to visual information in the graphics and motion planning module GMP, which are then forwarded to a graphics and motion rendering module GMR, and rendered therein.

In the light signal planning module LSR, the semantic representation sr of a sentence is converted to a corresponding light pattern, which is then forwarded to a light signal rendering module LSR and output as a light signal ls.

In this dialog system DS, the semantic representation sr as such is directly analysed by the output planning module OP to create a time synchronous control stream, which is then processed by the speech rendering module SR, the light signal rendering module LSR and the graphics and motion rendering module GMR and converted into audio-visual output.

The block diagram of FIG. 2 shows a communication device, in particular a dialog system DS. The dialog system DS once again comprises a speech rendering module SR for outputting synthesized speech, and a light signal rendering module LSR for outputting light signals.

A processor unit, equipped with the necessary software, analyses the semantic representation sr to be output, in order to extract the semantic tags which characterise the output speech. Extractable semantic tags are stored together with light patterns assigned to these tags in a storage unit SPE which can be accessed by the processor unit PE.

The processor unit PE is realised in such a way that it can access the storage unit SPE to retrieve the light patterns associated with the semantic tags extracted from the output speech. These light patterns or appropriate control information are forwarded to the light signal rendering unit LSR, so that output of the corresponding light signals can take effect. The output of the corresponding speech takes effect simultaneously in the speech rendering module SR.

Furthermore, the processor unit PE can be realised in such a way, that basic functions of a Text-To-Speech (TTS) converter, a speech analysis process for extracting semantic markers, an output planning module OP, and a dialog management module DM can be carried out.

Although the present invention has been disclosed in the form of preferred embodiments and variations thereon, it will be understood that numerous additional modifications and variations could be made thereto without departing from the scope of the invention. For example, the output rendering modules described are merely examples, which can be supplemented or modified by a person skilled in the art, without leaving the scope of the invention.

For the sake of clarity, it is to be understood that the use of “a” or “an” throughout this application does not exclude a plurality, and “comprising” does not exclude other steps or elements.

1. A method of communication by means of a communication device (DS),
in which synthesized speech (ss) is output from the communication device (DS),
and in which light signals (ls) are output simultaneously with the synthesized speech (ss) in accordance with the semantic content of the synthesized speech (ss).

2. A method according to claim 1, in which the output light signals (ss) depend on the prosodic content of the synthesized speech (ss).

3. A method according to claim 1, in which the colour of the output light signals (ls) depends on the synthesized speech (ss).

4. A method according to claim 1, in which the intensity of the output light signals (ls) depends on the synthesized speech (ss).

5. A method according to claim 1, in which the duration of the output light signals (ls) depends on the synthesized speech (ss).

6. A method according to claim 1, in which the shape of the output light signals (ls) depends on the synthesized speech (ss).

7. A method according to claim 1, in which the output light signals (ls) are based on previous light patterns.

8. A method according to claim 1, whereby
semantic tags are constructed from the output text and/or an abstract representation of the output text (sr),
a light pattern is assigned to each semantic tag,
and light signals (ls) are output simultaneously with the synthesized speech (ss), which light signals (ls) correspond to the light patterns assigned to the extracted semantic markers.

9. A communication device (CD), comprising
a speech output unit (SR) for outputting synthesized speech (ss),
a light signal output unit (LSR) for outputting light signals (ls), and
a processor unit (PE) configured so that the output light signals (ss) correspond to the semantic content of the output synthesized speech (ss).

10. A communication device (CD) according to claim 9, comprising a processor unit (PE) for constructing semantic tags from the output text and/or an abstract representation of the output text (sr) to be output.

11. A communication device (CD) according to claim t comprising a storage unit (SPE) for storing the semantic tags and for storing light patterns assigned are based on light patterns assigned to the semantic tags constructed from the output text and/or an abstract representation (sr) of the output text.

12. A dialog system comprising a communication device according to claim 9.
